(19) United States
(12) Patent Application Publication
(10) Pub. No.: US 2018/0016933 A1
(43) Pub. Date: Jan. 18, 2018

(54) METHOD AND SYSTEM FOR SOAK-BACK MITIGATION BY ACTIVE COOLING

(71) Applicant: General Electric Company, Schenectady, NY (US)

(72) Inventors: Mohamed Elbibary, West Chester, OH (US); Daniel Jean-Louis Laborie, West Chester, OH (US)

(21) Appl. No.: 15/207,640

(22) Filed: Jul. 12, 2016

(51) Int. Cl. F01D 21/00; F02C 7/18; F01D 21/12

(52) U.S. Cl. CPC F01D 21/003; F01D 21/12; F02C 7/18

(57) ABSTRACT

A method of mitigating soak-back in a gas turbine engine including an engine core compartment and an active engine core compartment cooling system are provided. The active engine core compartment cooling system includes an aperture extending through a core engine cowl forming a radially outer wall of the engine core compartment. The active engine core compartment cooling system also includes a cooling fan mounted within the engine core compartment and including a cooling fan inlet and a cooling fan outlet. The cooling fan inlet is coupled in flow communication with the aperture. The cooling fan outlet is coupled in flow communication with the engine core compartment. The active engine core compartment cooling system further includes a cooling fan controller configured to at least one of control a rotational speed of the cooling fan and control a position of at least one flow control valve coupled in series flow communication with the cooling fan.

### BACKGROUND

The field of the disclosure relates generally to gas turbine engines and, more particularly, to a method and system for active cooling of gas turbine engine compartments and/or components after engine shutdown.

Gas turbine engines typically include an undercowl space or engine core compartment as a part of the engine architecture. As gas turbine engine efficiency is improved to, for example, provide higher aircraft speed or higher specific fuel consumption (SFC), pressure ratios of fans and compressors and internal temperatures are expected to rise substantially, resulting in higher temperature for the engine core compartment and components. Engine core compartment components include electronics and other line replaceable units (LRUs). Such electronic components in known gas turbine engines, including full authority digital engine (or electronics) controls (FADECs), may be particularly sensitive to increasing engine core compartment temperatures both during gas turbine engine operation and during soak-back after engine shutdown. Although the electronics are not located in the hottest portion of the engine, such as those portions exposed directly to combustion products, heat from various hot portions of an operating gas turbine can be conducted to the location of the electronics, causing the temperature of the electronics to rise.

In addition to experiencing elevated temperatures during operation, the electronics may be exposed to even higher temperatures during the period after engine shut down. During this time period, the hot portions of the engine continue to radiate and conduct heat into the surrounding engine mass as they cool, but there is no airflow through the engine to help carry heat away from the rest of the engine. As a result, the temperature of some of the electronics may actually rise as the hottest engine portions cool down. Electronics temperatures can exceed 500° Fahrenheit during this period of time typically referred to as “soak-back.”

Such temperatures can have undesirable effects on electrical and electronic components. For example, the components that make up electronics equipment can break down. While an abrupt catastrophic failure of an electronic component may not always occur, progressive breakdown due to elevated temperature and thermal cycling can reduce the usable lifetime of such electronic components.

Known systems with radiation shields add weight to gas turbine engines and, therefore, increase the specific fuel consumption (SFC). Where such components are placed at remote locations in the engine, increases in the length of connecting cables also increases engine weight and SFC while also complicating maintenance activities. Furthermore, in such known gas turbine engines, such problems are compounded during soak-back where there is no cooling flow and an extended time must be waited after operation of such known gas turbine engines before servicing them. Some known systems and methods for cooling engine core compartment components also increase operating costs of at least some known gas turbine engines.

For example, servicing electronics in at least some known gas turbine engines requires the engine to remain in ground idle (GI) for at least 3 minutes after flight. In such known gas turbine engines, strategies to cool electronic engine core compartment components include changing materials of construction, and modifying engine architecture by placing heat radiation shields around electronics and by moving components to remote locations.

Hot soak-back environment is also detrimental to the life of many undercowl components. Even though engine components are qualified to survive such environment, hot temperatures tend to degrade their internal seals resulting in additional air and/or fuel/ oil leakages, causing degradation of engine performance and potentially requiring flight line disruption when components need to be replaced.

Hot soak-back environment can cause fuel coking in fuel components and lines, and fuel nozzles that will degrade engine operation and will eventually cause flight line disruption when components need to be replaced.

The soak-back environment results in uneven cooling of the engine stators and rotors. The undercowl acts basically as an oven, with large temperature gradients from bottom to top of the compartment, resulting in uneven cooling of the compressor cases. As a consequence, compressor clearances are uneven which can result in compressor rubs during the subsequent engine start as the best, and locked rotor at the worst. Compressor rubs result in a permanent engine performance degradation resulting in increased fuel consumption which is costly for airline operation. This situation has been mitigated on some engines by extensive dry engine motoring prior to ground engine starts which is a burden for airline operations.

### BRIEF DESCRIPTION

In one aspect, an active engine core compartment cooling system includes an aperture extending through a core engine cowl forming a radially outer wall of the engine core compartment. The active engine core compartment cooling system also includes a cooling fan mounted within the engine core compartment and including a cooling fan inlet and a cooling fan outlet. The cooling fan inlet is coupled in flow communication with the aperture. The cooling fan outlet is coupled in flow communication with the engine core compartment. The active engine core compartment cooling system further includes a cooling fan controller configured to at least one of control a rotational speed of the cooling fan and control a position of at least one flow control valve coupled in series flow communication with the cooling fan.

In another aspect, a method of mitigating soak-back in a gas turbine engine including an engine core compartment includes receiving indication of at least one of weight on wheels (WOW) and a fan speed of the gas turbine engine being less than a predetermined threshold and initiating a flow of cooling air from outside the engine core compartment into the engine core compartment based on the received indication.

In yet another aspect, a turbofan engine includes a core engine including an engine core compartment at least partially circumscribing the core engine and a core engine cowl forming a radially outer wall of the engine core compartment. The turbofan engine also includes a fan powered by a power turbine driven by gas generated in the core engine, a fan bypass duct at least partially surrounding the core engine and the fan. The turbofan engine further includes an aperture extending through the core engine cowl to the bypass duct at least partially surrounding the engine core compartment and a cooling fan mounted within the engine core compartment and including a cooling fan inlet and a cooling fan outlet The cooling fan inlet is coupled in flow communication with the aperture. The cooling fan outlet is coupled in flow communication with the engine core compartment. The turbofan engine also includes a cooling fan controller configured to at least one of control a rotational speed of the cooling fan and control a position of at least one flow control valve coupled in series flow communication with the cooling fan.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an aircraft.

FIG. 2 is a schematic cross-sectional view of the gas turbine engine shown in FIG. 1 in accordance with an exemplary embodiment of the present disclosure.

FIG. 3 is an enlarged schematic cross-sectional view of the gas turbine engine shown in FIG. 1 illustrating an active engine core compartment cooling system in accordance with an example embodiment of the present disclosure.

FIG. 4 is a data flow diagram for the controller shown in FIG. 3.

FIG. 5 is a process flow chart of an algorithm for controlling the active engine core compartment cooling system shown in FIG. 3.

FIG. 6 is a flow chart of a method of mitigating soak-back in a gas turbine engine including an engine core compartment.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

Embodiments of the active engine core compartment cooling system described herein effectively decrease the temperature of core undercowl components, including temperature sensitive electronics such as full authority digital engine (or electronics) controls (FADECs) and fuel operated valves, and components, during soak-back of gas turbine engines. Also, the soak-back mitigation through active cooling systems and methods described herein permits to provide core compartment ventilation during soak-back, thereby eliminating the need for dry motoring prior to engine starts and/or reducing the risk of compressor rubs during engine starts. Moreover, the soak-back mitigation through active cooling systems and methods described herein make it possible to reduce post-flight ground idle (GI) time before maintenance activities on gas turbine engines may be performed. Further, the soak-back mitigation through active cooling systems and methods described herein reduce the specific fuel consumption (SFC) of gas turbine engines by replacing radiation shields with lower weight active cooling system components and methods including a cooling fan and light weight headers configured to direct air directly to the most heat affected components and areas. Furthermore, the soak-back mitigation through active cooling systems and methods described herein simplify maintenance activities on undercowl components and reduce operating costs of gas turbine engines by avoiding having to change materials of construction of undercowl components and having to change engine architecture to move undercowl components to remote and more difficult to service locations.

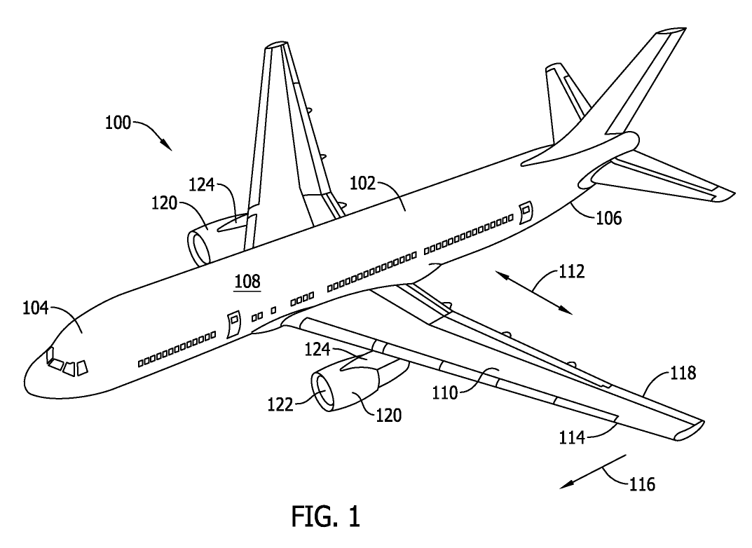

FIG. 1 is a perspective view of an aircraft 100. In the example embodiment, aircraft 100 includes a fuselage 102 that includes a nose 104, a tail 106, and a hollow, elongate body 108 extending therebetween. Aircraft 100 also includes a wing 110 extending away from fuselage 102 in a lateral direction 112. Wing 110 includes a forward leading edge 114 in a direction 116 of motion of aircraft 100 during normal flight and an aft trailing edge 118 on an opposing edge of wing 110. Aircraft 100 further includes at least one engine 120 configured to drive a bladed rotatable member 122 or fan to generate thrust. At least one engine 120 is connected to an engine pylon 124, which may connect the turbofan engine at least one engine 120 to aircraft 100. Engine pylon 124, for example, may couple at least one engine 120 to at least one of wing 110 and fuselage 102, for example, in a pusher configuration (not shown) proximate tail 106.

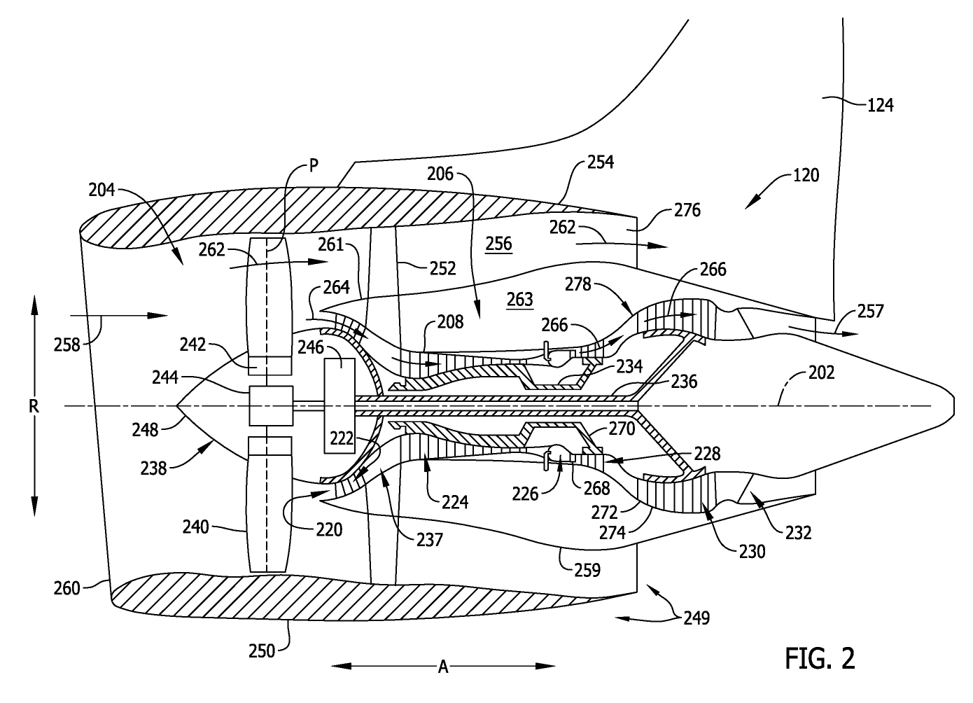

FIG. 2 is a schematic cross-sectional view of gas turbine engine 120 in accordance with an exemplary embodiment of the present disclosure. In the example embodiment, gas turbine engine 120 is embodied in a high-bypass turbofan jet engine. As shown in FIG. 2, turbofan engine 120 defines an axial direction A (extending parallel to a longitudinal axis 202 provided for reference) and a radial direction R. In general, turbofan 120 includes a fan assembly 204 and a core turbine engine 206 disposed downstream from fan assembly 204.

In the example embodiment, core turbine engine 206 includes an approximately tubular engine casing 208 that defines an annular inlet 220. Engine casing 208 encases, in serial flow relationship, a compressor section including a booster or low pressure (LP) compressor 222 and a high pressure (HP) compressor 224; a combustion section 226; a turbine section including a high pressure (HP) turbine 228 and a low pressure (LP) turbine 230; and a jet exhaust nozzle section 232. A high pressure (HP) shaft or spool 234 drivingly connects HP turbine 228 to HP compressor 224. A low pressure (LP) shaft or spool 236 drivingly connects LP turbine 230 to LP compressor 222. The compressor section, combustion section 226, turbine section, and nozzle section 232 together define a core air flowpath 237.

In the example embodiment, fan assembly 204 includes a variable pitch fan 238 having a plurality of fan blades 240 coupled to a disk 242 in a spaced apart relationship. Fan blades 240 extend radially outwardly from disk 242. Each fan blade 240 is rotatable relative to disk 242 about a pitch axis P by virtue of fan blades 240 being operatively coupled to a suitable pitch change mechanism (PCM) 244 configured to vary the pitch of fan blades 240. In other embodiments, pitch change mechanism (PCM) 244 is configured to collectively vary the pitch of fan blades 240 in unison. Fan blades 240, disk 242, and pitch change mechanism 244 are together rotatable about longitudinal axis 202 by LP shaft 236 across a power gear box 246. Power gear box 246 includes a plurality of gears for adjusting the rotational speed of fan 238 relative to LP shaft 236 to a more efficient rotational fan speed.

Disk 242 is covered by rotatable front hub 248 aerodynamically contoured to promote an airflow through the plurality of fan blades 240. Additionally, fan assembly 204 and at least a portion of core turbine engine 206 are surrounded by a nacelle assembly 249, which may include an annular fan casing or outer nacelle 250 that circumferentially surrounds fan 238 and/or at least a portion of core turbine engine 206. In the example embodiment, nacelle 250 is configured to be supported relative to core turbine engine 206 by a plurality of circumferentially-spaced outlet guide vanes 252. Moreover, a downstream section 254 of nacelle 250 may extend over an outer portion of core turbine engine 206 so as to define a bypass duct 256 therebetween.

Nacelle assembly 249 is a system of components or structures attached to turbofan engine 120 and/or engine pylon 124, which provides aerodynamic surfaces around turbofan engine 120, defines a portion of bypass flowpath 262, defines an appropriate inlet 220 for core flowpath 264 and bypass flowpath 262, defines appropriate nozzles for the exhaust of bypass duct 256 and a core exhaust 257, and houses or contains auxiliary devices for the engine and other components for the aircraft including various ducts, lines, pipes and wires. Nacelle assembly 249 may be subdivided into an outer structure or fan cowl 250 and an inner structure or core engine cowl 259 generally separated by bypass duct 256. Outer structure 250 may include an inlet 260 and a fan cowl 250 (which generally overlaps the fan case of the engine). Outer structure 250 may also partially overlap a forward portion 261 of inner structure 259 with outer structure 250 providing a radially outer wall for bypass duct 256 and inner structure 259 providing a radially inner wall.

Inner structure 259 forms at least a part a generally cylindrical or barrel-shaped cowl formed around the engine casing 208 and helps define an engine core compartment 263. Inner structure 259 houses and is configured to provide an aerodynamic cover for engine casing 208.

During operation of turbofan engine 120, a volume of air 258 enters turbofan 120 through an associated inlet 260 of nacelle 250 and/or fan assembly 204. As volume of air 258 passes across fan blades 240, a first portion 262 of volume of air 258 is directed or routed into bypass duct 256 and a second portion 264 of volume of air 258 is directed or routed into core air flowpath 237, or more specifically into LP compressor 222. A ratio between first portion 262 and second portion 264 is commonly referred to as a bypass ratio. The pressure of second portion 264 is then increased as it is routed through high pressure (HP) compressor 224 and into combustion section 226, where it is mixed with fuel and burned to provide combustion gases 266.

Combustion gases 266 are routed through HP turbine 228 where a portion of thermal and/or kinetic energy from combustion gases 266 is extracted via sequential stages of HP turbine stator vanes 268 that are coupled to engine casing 208 and HP turbine rotor blades 270 that are coupled to HP shaft or spool 234, thus causing HP shaft or spool 234 to rotate, which then drives a rotation of HP compressor 224. Combustion gases 266 are then routed through LP turbine 230 where a second portion of thermal and kinetic energy is extracted from combustion gases 266 via sequential stages of LP turbine stator vanes 272 that are coupled to engine casing 208 and LP turbine rotor blades 274 that are coupled to LP shaft or spool 236, which drives a rotation of LP shaft or spool 236 and LP compressor 222 and/or rotation of fan 238.

Combustion gases 266 are subsequently routed through jet exhaust nozzle section 232 of core turbine engine 206 to provide propulsive thrust. Simultaneously, the pressure of first portion 262 is substantially increased as first portion 262 is routed through bypass duct 256 before it is exhausted from a fan nozzle exhaust section 276 of turbofan 120, also providing propulsive thrust. HP turbine 228, LP turbine 230, and jet exhaust nozzle section 232 at least partially define a hot gas path 278 for routing combustion gases 266 through core turbine engine 206.

Turbofan engine 120 is depicted in FIG. 1 by way of example only, and that in other exemplary embodiments, turbofan engine 120 may have any other suitable configuration including for example, a turboprop engine.

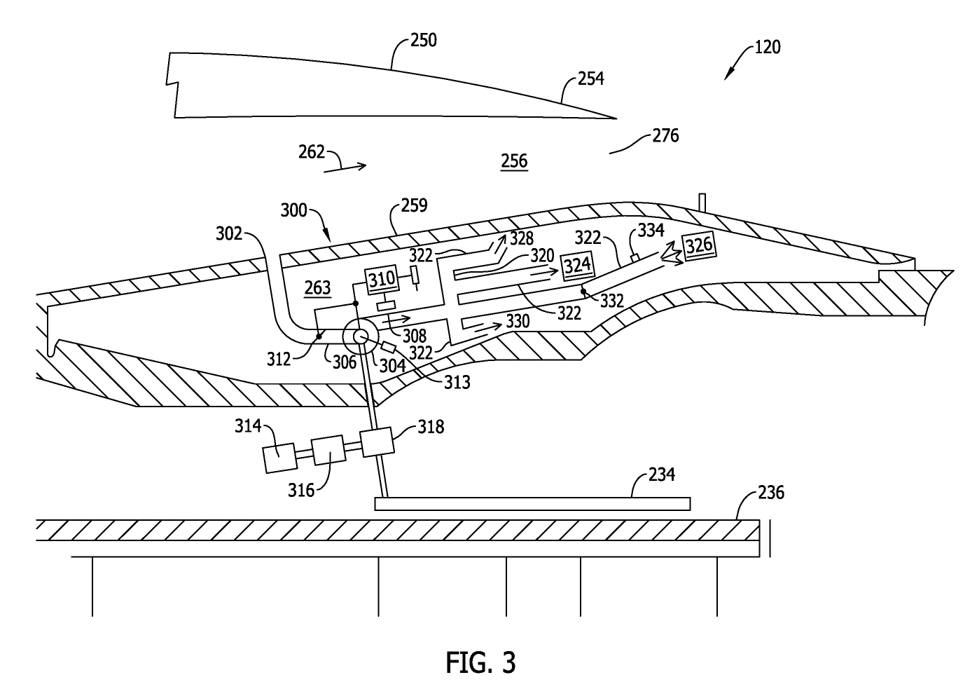

FIG. 3 is an enlarged schematic cross-sectional view of gas turbine engine 120 illustrating an active engine core compartment cooling system 300 in accordance with an example embodiment of the present disclosure. In the example embodiment, active engine core compartment cooling system 300 includes an aperture 302 extending through core engine cowl 259 forming a radially outer wall of engine core compartment 263. Aperture 302 extends from engine core compartment 263 to bypass duct 256 that at least partially surrounds engine core compartment 263. Engine core compartment cooling system 300 includes a cooling fan 304 mounted within engine core compartment 263 and includes a cooling fan inlet 306 and a cooling fan outlet 308. Cooling fan inlet 306 is coupled in flow communication with aperture 302. Cooling fan outlet 308 is coupled in flow communication with engine core compartment 263. A cooling fan controller 310 is configured to at least one of control a rotational speed of cooling fan 304 and control a position of at least one flow control valve 312 coupled in series flow communication with cooling fan 304. Cooling fan controller 310 is configured to receive at least one of a weight on wheels (WOW) signal, an engine speed signal and at least one flow control valve 312 and/or an indication of the engine fuel shut-off valve position for determining an operations schedule for cooling fan 304.

In various embodiments, cooling fan 304 is powered by an electric motor 313. In other embodiments, cooling fan 304 is powered by a turning motor 314 mechanically coupled to at least one of rotor 234 and 236 through at least one of a clutch 316 and a gearbox 318 arrangement. Cooling fan 304 may also be powered from turning motor 314 with clutch 316 engaged or may be powered by a residual momentum of rotors 234 or 236 with clutch 316 disengaged. Similarly, cooling fan 304 may be powered from rotors 234 or 236 through gearbox 318 even in an embodiment without turning motor 314 and clutch 316 installed. In another embodiment, the electrical power is provided by thermo-electric effect, taking advantage of the temperature difference between the hot engine cases and the cold engine structure (such as the fan frame for example).

In some embodiments, a distribution header 320 is coupled to cooling fan outlet 308. In some embodiments, distribution header 320 supplies a plurality of cooling branches 322 wherein each branch is configured to channel a flow of cooling air from cooling fan 304 to a component, such as, but not limited to a line replaceable units (LRU) 324 and a full authority digital engine (or electronics) controls (FADEC) 326 within engine core compartment 263 or to an area 328, 330 within engine core compartment 263 itself. In various embodiments, one or more cooling branches 322 include at least one of a branch flow control valve 332 and a temperature sensor 334.

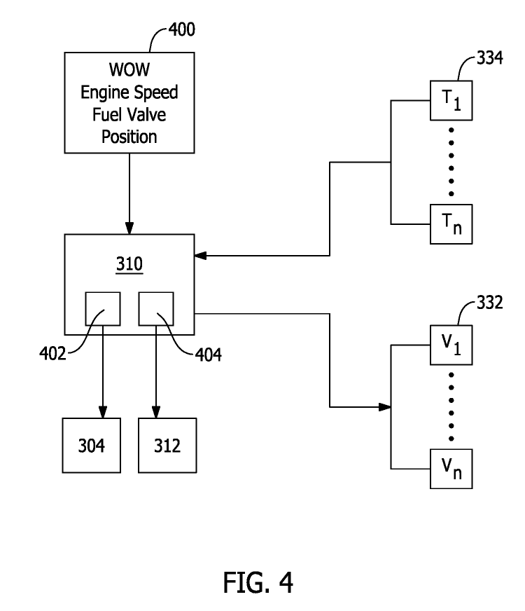

FIG. 4 is a data flow diagram 400 for controller 310 (shown in FIG. 3). In the example embodiment, controller 310 is configured to receive signals from various signal sources onboard or off board aircraft 100 either wirelessly or though wired conduits. In one embodiment, controller 310 is configured to receive weight on wheels (WOW) signal and an engine speed signals 400 from, for example, an aircraft flight control computer (not shown), LRUs 324, or FADECs 326. In another embodiment, the controller receives indication of the engine fuel shut-off valve position. Controller 310 is also configured to receive temperature signals for various areas 328 and 330 within engine core compartment 263 and/or from components 324 and/or 326. Controller 310 is configured to generate control signals to control the operation of branch flow control valves 332, at least one flow control valve 312 and cooling fan 304. Controller 310 uses a processor 402 communicatively coupled to a memory device 404 to execute instructions that process algorithms, physics models, and/or look-up tables to generate such signals.

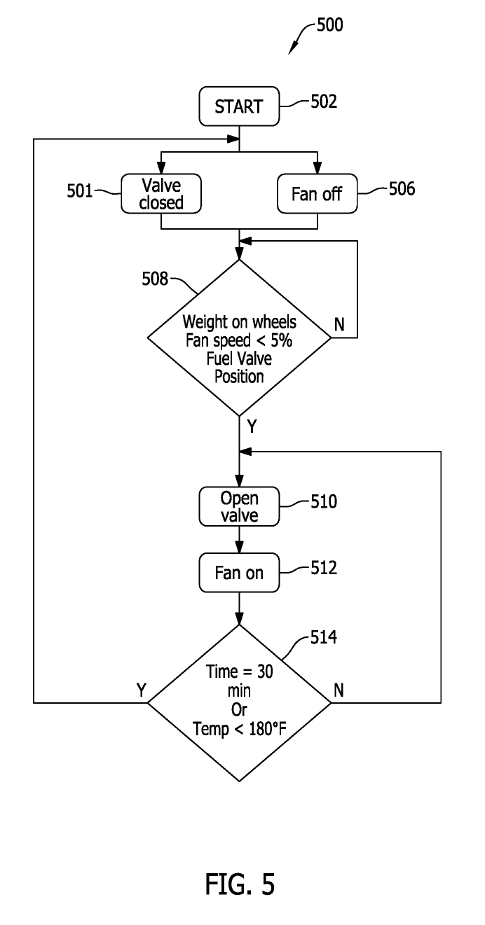

FIG. 5 is a process flow chart 500 of an algorithm for controlling active engine core compartment cooling system 300. Active engine core compartment cooling system 300 starts 502 with at least one flow control valve 312 closed 504 and/or cooling fan 304 off 506. The algorithm iteratively checks 508 for a weight on wheels signal that indicates the aircraft has landed and is on the ground, an indication that engine speed is less than a predetermined threshold, such as, 5% of rated full speed, and/or engine fuel shut-off valve indication. When any of such indications or other indications that may be used to indicate a need for cooling in engine core compartment 263, are received, controller 310 commands at least one flow control valve 312 to open 504 and/or cooling fan 304 to start 506. In some embodiments, at least one flow control valve 312 and cooling fan 304 may be used independently to supply cooling to engine core compartment 263. For example, at least one flow control valve 312 may be used by itself to supply ram air to engine core compartment 263 while aircraft 100 is still moving sufficiently to provide enough head to drive air into engine core compartment 263. The algorithm iteratively checks 514 for various conditions at which the algorithm will secure active engine core compartment cooling system 300. For example, the algorithm may shutdown active engine core compartment cooling system 300 after a predetermined operating period, such as, but not limited to, approximately 30 minutes. Processor 402 may be used to determine the operating period needed to sufficiently cool engine core compartment 263 and/or components therein. Processor 402 may be used to determine 514 the operating period using the process algorithm, physics models, and/or look-up tables. Moreover, the time period may be determined by another processor and then communicated to processor 402 or other component of active engine core compartment cooling system 300. Processor 402 may be used to operate cooling fan 304 and flow control valve 312 based on a temperature demand within engine core compartment 263. For example, the algorithm may maintain cooling fan 304 and flow control valve 312 in operation as long as a temperature of a component within engine core compartment 263 or the engine core compartment 263 itself is above a predetermined temperature threshold. The algorithm may also consider the closed position of the aircraft fire handle to shut-off the cooling system and therefore suppress the ventilation airflows in case of an engine fire.

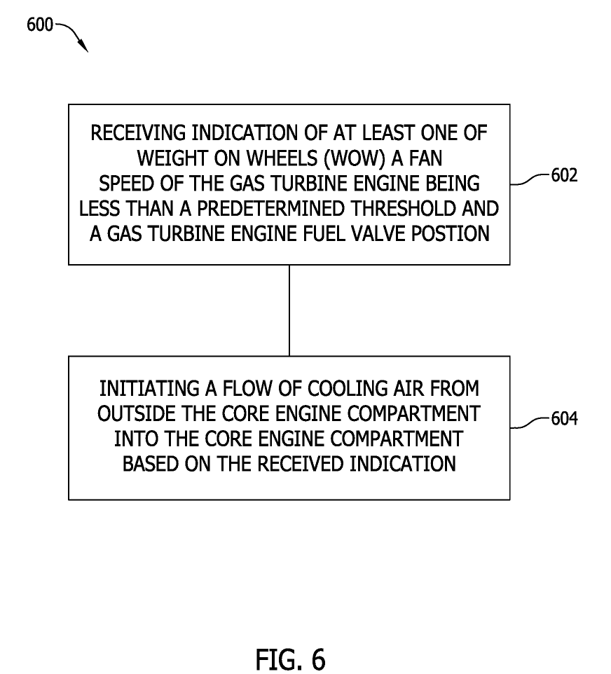

FIG. 6 is a flow chart of a method 600 of mitigating soak-back in a gas turbine engine including an engine core compartment. Method 600 includes receiving 602 indication of at least one of weight on wheels (WOW) and a fan speed of the gas turbine engine being less than a predetermined threshold and initiating 604 a flow of cooling air from outside the engine core compartment into the engine core compartment based on the received indication.

The above-described cooling systems provide an efficient method for active cooling of gas turbine engine turbine components. Specifically, the above-described active engine core compartment cooling system includes a mechanically or electrically driven cooling fan that takes a suction on a space external to the engine core compartment and supplies cooling air to components within the engine core compartment or to the engine core compartment itself. The speed of the cooling fan or the position of the cooling fan cooling air flow control valve may be modulated to provide a particular amount of cooling to the components within the engine core compartment or to the engine core compartment itself. Additionally, active engine core compartment cooling system may operate to provide maximum cooling to engine core compartment at all times by, for example, not including a cooling air flow control valve at all or by maintaining cooling air flow control valve in a fully open position. To supply maximum cooling, rather than operating the cooling fan at variable speeds, a single speed cooling fan may be used.

An exemplary technical effect of the methods, systems, and apparatus described herein includes at least one of: (a) providing a flow of cooling air into the engine core compartment 263 or undercowl space during or after shut down using an electric or geared driven fan to quickly introduce cooling air to the undercowl space, which reduces the soak-back global environment, (b) reducing weight and save specific fuel consumption by eliminating radiation shields for components at soak-back, (c) permitting early shutdown of aircraft engines, which saves fuel and operation costs, (d) eliminating a need to move components to remote, less heat-affected locations, thereby simplifying engine architecture for easier maintenance, (e) eliminating a need to redesign components to increase the components temperature limits by changing material, yielding a component cost reduction, (f) eliminating radiation shields thereby reducing engine weight and SFC, and reducing or eliminating a ground idle requirement for cooling down the under cowl components thereby reducing operation costs, (g) eliminating a risk of fuel or oil coking in the engine components and tubing during soak-back, (h) reducing the risk of compressor rubs during subsequent engine starts, and (i) eliminating the need of long dry motoring periods prior to engine starts.

The above-described embodiments of a method and active engine core compartment cooling system solve cooling problems related to a soak-back environment related to engine operation and a reduction in cooling that occurs when the engine lands and reduces engine speed. This results in operational and maintenance cost savings from a reduced fuel burn and increased life of components in the affected areas. More specifically, the methods and systems described herein facilitate cooling engine core compartment components when the normal methods of cooling are unavailable and before land-based methods of cooling can be initiated. As a result, the methods and systems described herein facilitate reducing operating and maintenance requirements in a cost-effective and reliable manner.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An active engine core compartment cooling system comprising:
an aperture extending through a core engine cowl that forms a radially outer wall of the engine core compartment;
a cooling fan mounted within the engine core compartment and comprising a cooling fan inlet and a cooling fan outlet, the cooling fan inlet coupled in flow communication with said aperture, the cooling fan outlet coupled in flow communication with the engine core compartment; and
a cooling fan controller configured to at least one of control a rotational speed of said cooling fan and control a position of at least one flow control valve coupled in series flow communication with said cooling fan.

2. The system of claim 1, wherein said aperture extends from the engine core compartment to a bypass duct at least partially surrounding the engine core compartment.

3. The system of claim 1, wherein said cooling fan is electrically powered.

4. The system of claim 1, wherein said gas turbine engine comprises a rotor and a stator, said cooling fan powered by a turning motor mechanically coupled to the rotor.

5. The system of claim 1, wherein said cooling fan controller is configured to receive at least one of a weight on wheels (WOW) signal and an engine speed signal.

6. The system of claim 1, wherein said cooling fan controller is configured to control a speed of the cooling fan.

7. The system of claim 1, wherein said at least one flow control valve comprises a plurality flow control valves.

8. The system of claim 1, further comprising a distribution header coupled to said cooling fan outlet, said distribution header comprising a plurality of branches, each branch configured to channel a flow of air from said cooling fan to a component within the engine core compartment.

9. The system of claim 8, wherein each branch comprises at least one of a branch flow control valve and a temperature sensor.

10. A method of mitigating soak-back in a gas turbine engine including an engine core compartment, said method comprising:
receiving indication of an imminent shutdown of the gas turbine engine; and
initiating a flow of cooling air from outside the engine core compartment into the engine core compartment based on the received indication.

11. The method of claim 10, wherein receiving indication of an imminent shutdown of the gas turbine engine comprises receiving an indication of at least one of weight on wheels (WOW), a fan speed of the gas turbine engine being less than a predetermined threshold, and an indication of a position of a fuel shut-off valve of the gas turbine engine.

12. The method of claim 10, wherein receiving indication of an imminent shutdown of the gas turbine engine comprises receiving indication of at least one of weight on wheels (WOW), a fan speed of the gas turbine engine less than approximately 5 percent of rated full speed, and an indication of a position of a fuel shut-off valve of the gas turbine engine.

13. The method of claim 10, further comprising storing a look-up table of valve position versus a determined cooling requirement.

14. The method of claim 10, wherein initiating a flow of cooling air from outside the engine core compartment into the engine core compartment comprises initiating a flow of cooling air from outside the engine core compartment into the engine core compartment using a cooling fan.

15. The method of claim 10, further comprising modulating the flow of cooling air based on at least one of a temperature within the engine core compartment, a temperature of a component within the engine core compartment, and a temperature of at least a portion of the flow of cooling air.

16. A turbofan engine comprising:
a core engine including an engine core compartment at least partially circumscribing said core engine, a core engine cowl forming a radially outer wall of the engine core compartment;
a fan powered by a power turbine driven by gas generated in said core engine;
a fan bypass duct at least partially surrounding said core engine and said fan; and
an aperture extending through the core engine cowl to the bypass duct at least partially surrounding the engine core compartment;
a cooling fan mounted within the engine core compartment and comprising a cooling fan inlet and a cooling fan outlet, the cooling fan inlet coupled in flow communication with said aperture, the cooling fan outlet coupled in flow communication with the engine core compartment; and
a cooling fan controller configured to at least one of control a rotational speed of said cooling fan and control a position of at least one flow control valve coupled in series flow communication with said cooling fan.

17. The engine of claim 16, wherein said gas turbine engine comprises a rotor and a stator, said cooling fan powered by a turning motor mechanically coupled to the rotor.

18. The engine of claim 16, wherein said gas turbine engine comprises a rotor and a stator, said cooling fan powered by a momentum of the rotor.

19. The engine of claim 16, wherein said cooling fan is driven by an electric motor.

20. The engine of claim 16, wherein said cooling fan controller is configured to receive at least one of a weight on wheels (WOW) signal and an engine speed signal.

21. The engine of claim 16, further comprising a distribution header coupled to said cooling fan outlet, said distribution header comprising a plurality of branches, each branch configured to channel a flow of air from said cooling fan to a component within the engine core compartment.
